(19) United States
(12) Patent Application Publication
(10) Pub. No.: US 2026/0311102 A1
(43) Pub. Date: Oct. 8, 2026

(54) AI-DRIVEN WORKFORCE DEVELOPMENT

(71) Applicant: Vigilant IP Holdings LLC, West Chester, OH (US)

(72) Inventor: Christopher M. Nyhuis, Liberty Township, OH (US)

(73) Assignee: Vigilant IP Holdings LLC, West Chester, OH (US)

(21) Appl. No.: 19/642,420

(22) Filed: Apr. 8, 2026

Related U.S. Application Data
(60) Provisional application No. 63/785,114, filed on Apr. 8, 2025.

(51) Int. Cl. G06Q 10/0639

(52) U.S. Cl. CPC G06Q 10/06398; G06Q 10/06393

(57) ABSTRACT

The present disclosure describes systems and methods to enhance workforce development, employee efficiency, and training opportunities through AI/ML assistance during regular workforce tasks. The systems and methods support allows employers to effectively train employees without the added pressures of explicit skills testing. Employers can better understand the workforce while improving workforce skillsets and improving the operation of human-machine systems.

### REFERENCE TO RELATED APPLICATION

This application claims priority to U.S. Provisional Pat. App. No. 63/785,114, entitled “Methods and Systems for AI-Driven Workforce Development,” filed Apr. 8, 2025, the disclosure of which is incorporated by reference herein.

### FIELD

The disclosed technology pertains to artificial intelligence (AI)-driven learning. More specifically, the disclosed technology relates to AI-driven workforce development, skill assessment, and dynamic training systems.

### BACKGROUND

Organizations currently rely on static learning modules, time-in-seat metrics, and/or traditional testing to measure workforce expertise. Conventional AI-based training typically focuses on predefined lessons or periodic assessments. Additionally, many existing systems do not provide nuanced, adaptive aid that responds in real time to signs of skill regression. This gap can lead to inaccurate assessments of expertise, outdated skill sets, and inefficient training outcomes. Accordingly, there is a need for improvements in workforce development systems, particularly in monitoring user proficiency, testing user proficiency, and adaptive guidance.

### SUMMARY

Some embodiments of the disclosed technology may be used to address difficulties such as those described above. For example, this technology might be embodied in a workforce development system comprising a processor and a memory, the memory storing instructions whereby the processor is configured to perform the steps of collecting performance data about a user; assisting the user based on the performance data; presenting one or more skill tests to the user such that the user is unaware of the testing; analyzing the performance data with an AI/ML engine; and optimizing the assistance to the user based on the analyzed performance data. A further example is a method performed by a workforce development system for customizing and optimizing assistance, the method comprising collecting performance data about a user; providing assistance to the user based on the performance data; presenting one or more skill tests to the user such that the user is unaware of the testing; analyzing the performance data with an AI/ML engine; and optimizing the assistance to the user based on the analysis of the performance data.

It should be appreciated that all combinations of the foregoing concepts and additional concepts discussed in greater detail below (provided such concepts are not mutually inconsistent) are contemplated as being part of the inventive subject matter disclosed herein and to achieve the benefits as described herein.

### BRIEF DESCRIPTION OF THE DRAWINGS

The drawings and detailed description that follow are intended to be merely illustrative and are not intended to limit the scope of the invention as contemplated by the inventors. Other features, aspects, and advantages will become apparent from the description, the drawings, and the claims.

FIG. 1 is a block diagram depicting a workforce development system.

FIG. 2 is a block diagram depicting a method for adaptive workforce development and skill validation.

FIG. 3 is a block diagram depicting an exemplary AI mentorship model.

FIG. 4 is a block diagram depicting a method for an initial assessment.

FIG. 5 is a flow chart of training and inference pipelines for machine learning in accord with some embodiments under the present disclosure.

FIG. 6 is a block diagram of a neural network for use in various embodiments under the present disclosure.

FIG. 7 is a block diagram of a computing device for use in various embodiments under the present disclosure.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention, it being understood, however, that this invention is not limited to the precise arrangements shown.

### DESCRIPTION

The inventors have conceived of novel technology that, for the purpose of illustration, is disclosed herein as applied in the context of an AI-driven platform designed to enhance collaboration, decision-making, and document generation through interactions between human users and multiple specialized AI personas. While the disclosed applications of the inventors’ technology satisfy a long-felt but unmet need in the art of generative AI and adaptive learning, it should be understood that the inventors’ technology is not limited to being implemented in the precise manners set forth herein but could be implemented in other manners without undue experimentation by those of ordinary skill in the art in view of this disclosure. Accordingly, the examples set forth herein should be understood as being illustrative only and should not be treated as limiting.

### Example Application

Some implementations of the disclosed technology may be used to provide real-time mentorship and skill validation through monitoring user proficiency, triggering adaptive guidance, and hidden testing as needed using artificial intelligence/machine learning (AI/ML). A workforce development system may support monitoring user proficiency, triggering adaptive guidance, hidden testing, and/or the use of one or more AI/ML models. By reducing test anxiety, preventing skill decay, and seamlessly integrating into operational tasks, the disclosed technology may accelerate skill acquisition, lower training overhead, and adapt to multiple domains with data privacy and security. To illustrate how this may take place, this disclosure discusses the example of a user in training interacting with a workforce development system. However, it should be understood that this example is intended to be illustrative only, and that other implementations and applications of the disclosed technology are also possible and will be apparent to those of skill in the art in light of this disclosure. Accordingly, the discussion herein provides nonlimiting examples of how the disclosed technology may be applied in the context of human and AI training interactions.

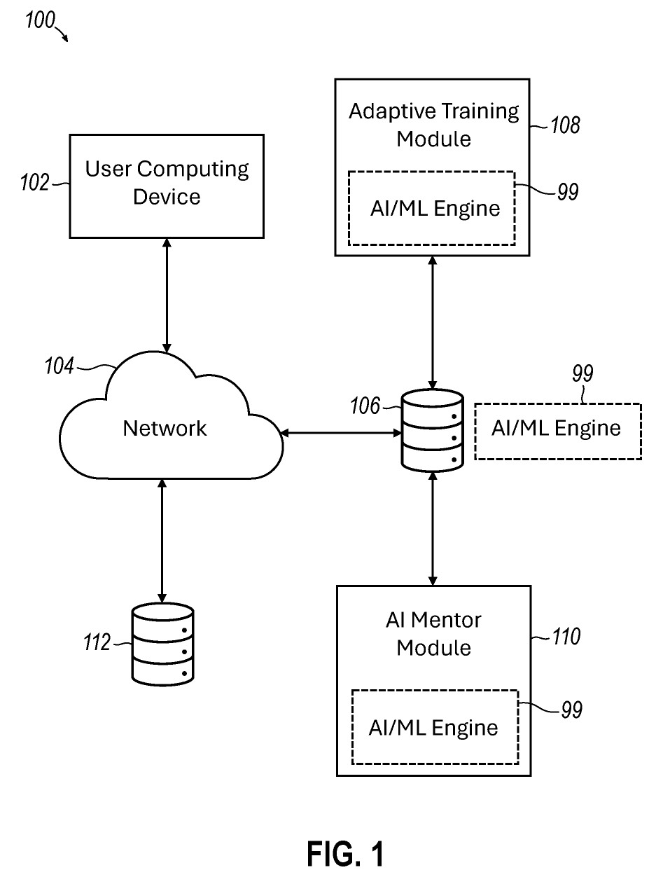

FIG. 1 illustrates a block diagram depicting a workforce development system 100. The workforce development system 100 may include one or more user computing devices 102 (e.g., computers, tablets, mobile devices, etc.), a network 104 (e.g., Internet, cellular, Bluetooth^{®}, Wi-Fi^{®}, satellite, enterprise, private network, similar networks, or combinations of the foregoing), one or more data management servers 112, and one or more workforce development servers 106. A user can access network 104 via one or more user computing devices 102 to complete work tasks. The one or more workforce development servers 106 may monitor the user in the background during performance of tasks to collect user performance data, determine a user proficiency baseline, provide aid to users on relevant tasks, and/or perform other functions. The one or more workforce development servers 106 may integrate with one or more data management servers 112 (e.g., via network 104) to perform a variety of the above functions as well as collect, monitor, or analyze external data, training data previously stored in data management servers 112, and/or internal data stored in data management servers 112, and/or perform other functions as described further below. External data sources may include data scraped from third-party websites, third-party apps, and/or other available sources. The data management servers 112 may track and store a user’s movements on the user computing devices 102, user biometric data, user expertise level, and/or other user performance data.

The one or more workforce development servers may include an adaptive training model 108, AI mentor module 110, and/or other models. The adaptive training model 108 may include one or more neural networks (NNs), one or more decision trees, one or more ensemble methods, one or more Bayesian models, one or more LLMs, and/or other AI/ML models. The AI mentor module 110 may include one or more NNs, one or more decision trees, one or more ensemble methods, one or more Bayesian models, one or more LLMs, and/or other AI/ML models. Various embodiments of workforce development system 100 may have AI/ML functionalities. AI/ML engine 99 may be stored or operated at various computing devices within workforce development system 100, the adaptive training model 108, and/or the AI mentor module 110. Any or all of workforce development servers 106, user computing devices 102, and/or data management servers 112 may comprise AI/ML engine(s) 99. AI/ML engines 99 may comprise or perform AI/ML functionality as described further herein.

In some embodiments, the AI mentor module 110 may perform like a “cognitive exoskeleton” by augmenting a user’s decision-making capabilities in real time. This may enable relatively inexperienced users to perform high-skill tasks with the support of adaptive AI guidance. As the user demonstrates growing expertise, the support may progressively withdraw, which may foster independence while preserving high performance. The AI mentor module 110 may support a symbiotic relationship where both human and machine adapt and grow over time. In some embodiments, the workforce development system 100 may facilitate symbiotic growth between a user and the AI mentor module 110. For example, as a user gains competence and autonomy, the AI mentor module 110 may adjust intervention patterns accordingly, and the AI mentor module 110 may refine guidance strategies through continuous learning, resulting in a mutual improvement loop.

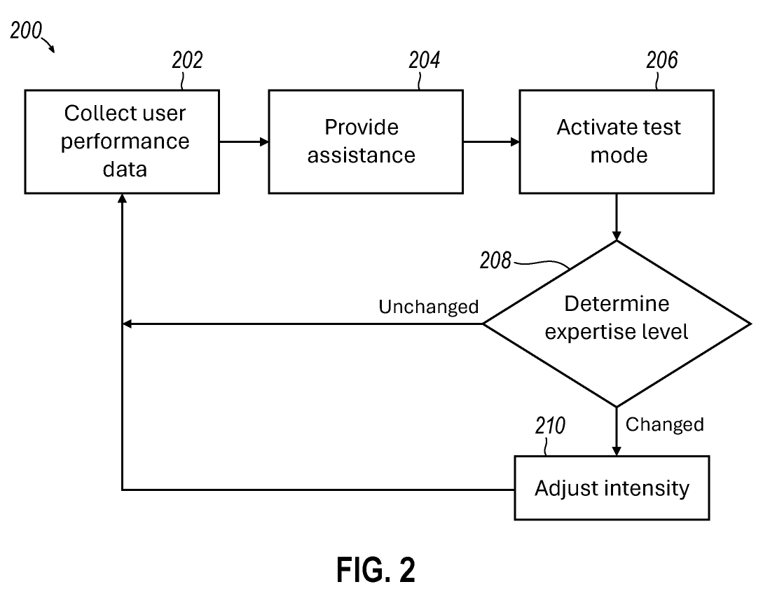

FIG. 2 illustrates a block diagram depicting a method for adaptive workforce development and skill validation 200 which may be performed by the workforce development system 100. Many jobs require tasks completed on a computer. A user may perform regular tasks on a computing device of the one or more user computing devices 102. Regular tasks may vary based on the job description. As the user performs regular tasks, the workforce development system 100 may begin collecting user performance data 212. Performance data may include speed, accuracy, mistake rates, and/or other data. As performance data is collected, the workforce development system 100 may provide assistance 204 to the user based on the performance data. For example, a cybersecurity professional may perform a log analysis and anomaly detection as part of the job. A new cybersecurity professional may take ten minutes longer to perform that analysis than a seasoned cybersecurity professional. The workforce development system 100 may detect this discrepancy and determine that providing assistance could reduce this discrepancy. The assistance may include prompts describing the process of performing a log analysis and anomaly detection, identifying the next button to press and/or location to go on the screen, or another type of aid. Provided assistance may include task hints, task instructions, identifying locations on the screen, motivational prompts, or other assistance. User performance data may be encrypted, subject to access control policies, or otherwise secured.

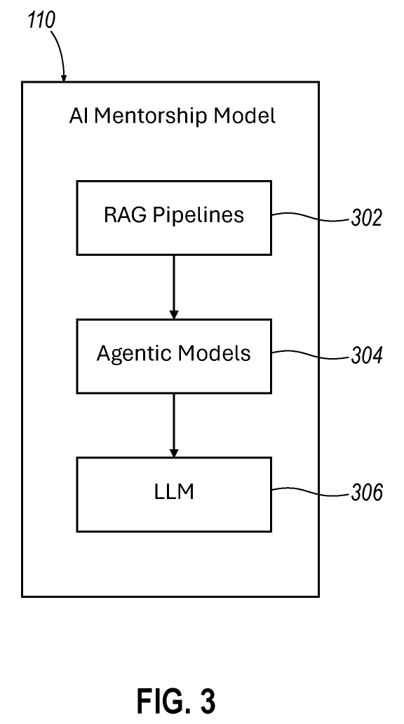

In some embodiments, like FIG. 1, the AI mentor module 110 may provide assistance. In some embodiments, as shown in FIG. 3, the AI mentor module 110 may be an LLM 306 capable of communicating with one or more retrieval-augmented generation (RAG) pipelines 302 and one or more agentic models 304. The LLM 306 may receive collected real-time user performance data 202 from the RAG pipelines 302. The one or more agentic models 304 may analyze the user performance data to determine what kind of assistance may be useful, what the next step for the user may be, or any other determinations that may aid in providing useful assistance to the user.

The one or more agentic models 304 may include one or more AI agents with each of the one or more AI agents trained in a specific task, a specific job, a specific industry, or other relevant area. For example, in cybersecurity, the AI agents may include an information security analyst agent, an IT security specialist agent, a security engineer agent, etc. The agentic models 304 may then communicate the relevant assistance information to the LLM 306 for communication with the user. In some embodiments, the LLM 306 may allow the user to ask questions and communicate in natural language such that the LLM 306 can further guide and/or assist the user with one or more tasks. For example, the user may receive a prompt from the LLM 306 to write a description of an incident in a certain text box. The user may not understand how to write the description or what the description should include. The user may ask the LLM 306 these questions and receive detailed responses to aid in the completion of the task. The workforce development system 100 may be customized for particular industries. This customization may be a configurable layer within the AI mentor module 110 that may train the agentic models 304 and/or LLM 306 on industry-specific data.

After assistance has been provided, test mode may be activated 206 based on the collected performance data. For example, if the new cybersecurity professional begins performing a log analysis without relying on the assistance, testing mode may be activated 206. Reliance may be determined by the speed at which the new cybersecurity professional moves through the log analysis, frequency of mistakes like misclicks or others, and/or other metrics. In some embodiments, this determination may include analysis of sentiment and/or biometric data, which may include analysis of typed text, eye tracking, keystroke cadence, voice, audio, facial expressions, and/or other data. Biometric data may be used to detect the user’s emotional states, such as frustration, fatigue, stress, confidence, or other states. Biometric data may be evaluated along with other performance data to determine one or more preferred mentorship styles, expertise level, optimal assistance timing, and/or other characteristics. This may be performed without disrupting a user’s workflow such that the assistance provided and the analysis may be—or may be perceived as—passive. Test mode may include selectively reducing the provided assistance based on the performance data.

In some embodiments, the AI mentor module may intentionally introduce adaptive friction by withholding standard prompts or guidance steps. This adaptive friction may serve to gently challenge a user, encouraging independent problem-solving and cognitive engagement. Friction level may be adjusted dynamically based on user performance and/or signs of dependency. For example, assistance that was previously given to the new cybersecurity professional while performing the log analysis may be slowly reduced such that the new cybersecurity professional must perform the log analysis, or parts of the log analysis, using only their own knowledge. Test mode may test the user without the user noticing the test by reducing prompts or otherwise subtly testing the user. This may allow for more accurate testing, as the user may not be aware of the testing, thus reducing testing anxiety and being less likely to cause disruption and/or inaccuracies in testing results, such as data errors due to the Hawthorne effect.

After test mode is activated 206, an expertise level can be determined 208 by analyzing performance data for regular tasks and determining if the performance data remains similar or differs after removing assistance. The expertise level may be a quantitative metric for the skill level of a user or another metric. If the performance data remains the same, the expertise level may be adjusted accordingly, and the intensity of the assistance provided may be adjusted 210 accordingly as well. In some embodiments, the assistance type, level of detail, or other element may change to better assist the user based on the performance data and/or expertise level. Intensity of assistance may be an amount of assistance prompts provided, level of detail in the provided assistance, or other change in the assistance. If the performance data differs, the expertise level may remain the same, and the intensity of the assistance provided may remain the same as it was prior to the test, that is, the assistance may be reinstated. For example, a user may transition from an “Intermediate” to “Advanced” level upon demonstrating sustained accuracy in tasks above 92%, average response time under 1.8 seconds, and fewer than two flagged interventions over a 30-day period. These thresholds may be configurable based on domain and/or organizational policies. Either way, after adjusting the intensity 210 or leaving the intensity as it was, the method 200 may start over by collecting user performance data 202. In some embodiments, even if the user no longer needs assistance, the method may continue running without providing assistance 204.

The method may continuously determine expertise level 208 and collect user performance data 202 such that, if a user’s proficiency begins declining, assistance may be reinstated accordingly. This may prevent skill decay in employees, prevent retraining, or otherwise reduce training costs. In some embodiments, the determination of expertise level 208 and/or the adjustment of the intensity of the assistance 210 may be performed by the adaptive training model 108. The adaptive training model 108 may be a neural network (“NN”) as described below. In some embodiments, the expertise level may be a designated level, for example, novice, intermediate, expert, etc. These expertise levels may be defined by particular metric thresholds or other considerations. For example, a novice cybersecurity professional may complete a relatively simple log analysis in two hours with three to five mistakes. An intermediate cybersecurity professional may complete a relatively simple log analysis in an hour and a half with one to three mistakes. An expert cybersecurity professional may complete a relatively simple log analysis in under one hour with zero to one mistake. In some embodiments, assistance intensity may be determined by a user’s expertise level. In other embodiments, assistance intensity may be determined by a user’s own performance data rather than an expertise level. In some embodiments, assistance intensity may be adjustable based on a user’s emotional state.

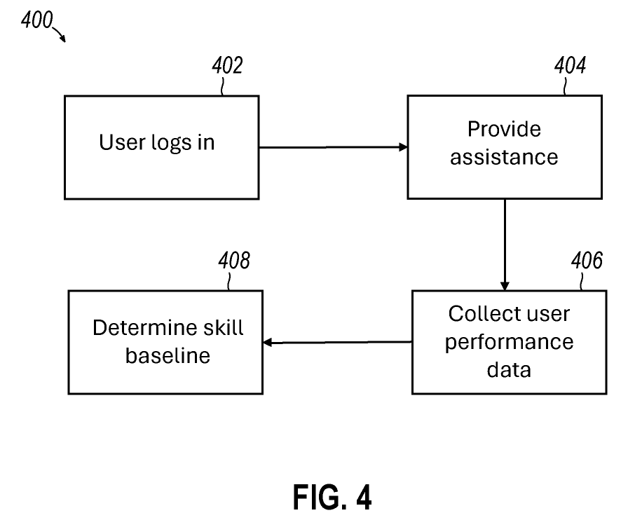

When a new user is added to the workforce development system 100, an onboarding process 400 may begin. This onboarding process 400 is illustrated in FIG. 4. First, the new user may log in 402 to a user computing device 102 which may trigger the onboarding process 400. The workforce development system 101 may then begin providing assistance 404 similar to the assistance provided 204 as shown in FIG. 2. However, the assistance provided in FIG. 4 may have a designated level of intensity and/or detail. In some embodiments, the designated level of intensity and/or detail may be such that a complete newcomer to the job may be able to perform tasks efficiently with assistance from the workforce development system 100. Then user performance data may be collected 406 as described in FIG. 2. The user performance data may then be analyzed to determine a skill baseline 408 for the new user. This determination 408 may be similar to the determination of expertise level 208 as described in FIG. 2. However, instead of comparing the change in metrics from a user previously to current metrics for the same user, the comparison may be between one or more predetermined efficiency thresholds for particular metrics and the new user’s metrics. The predetermined efficiency thresholds may be a speed at which the new user moves through one or more tasks, frequency of mistakes like misclicks or others, sentiment analysis, biometric data analysis, and/or other metrics, or a combination thereof.

In some embodiments, offline training options may be provided by the workforce development system 100, which may include articles, descriptions, or other documents for user review, quizzes, post-task summaries, or other training options.

In some embodiments, user performance data may be shared with supervisors and/or data analysts as a report such that employers can extract insights from the user performance data and/or intervene if a user is not improving. These reports may include heatmaps, dashboards, charts, and/or other graphic displays. For example, a supervisor may receive a heatmap showing a user’s skill level at varying skills relevant to their position. The user performance metrics may also be provided as logs showing assistance provided, user interactions, task outcomes, or other metrics for audit compliance or other purposes. This may include ensuring employees are complying with industry standards, region-specific regulations like the General Data Protection Regulation (GDPR), the Health Insurance Portability and Accountability Act (HIPAA), etc., or other regulations and/or standards. The workforce development system 100 may also provide training suggestions, discussions suggestions, and/or other suggestions to further aid in workforce training based on the user performance metrics. These suggestions may be generated by the AI mentor module 110 in a similar manner to generating user assistance as described in FIG. 3.

### AI/ML Embodiments

Various embodiments of the present disclosure can incorporate AI/ML functionality. For example, user computing devices 102, network 104, data management servers 112, and workforce development servers 106 of FIG. 1 can be said to comprise an AI/ML engine 99, either separately or together. Each component may comprise a separate instance of an identical AI/ML engine 99. Or a “central” AI/ML engine 99 could be running at any location, such as workforce development servers 106, and others of the foregoing devices could function like an output/input interface to the central AI/ML engine 99, allowing user input, data collection, user interface for a user, etc. As described above, data management servers 112 may collect, monitor, or analyze external data and/or user performance data previously stored data stored in data management servers 112 and/or internal data stored in data management servers 112 and/or other functions, or otherwise receive or utilize a variety of other data. This data can be used to analyze key tasks, typical task times, best prompts, assistance types, work styles, and other requirements, etc. This data can also be used to train AI/ML engine 99, or can be analyzed by a previously trained AI/ML engine 99.

It should be understood that AI/ML engine 99 can comprise one or more AI/ML engines. Commonly the terms machine learning engine or machine learning algorithm are used to refer to a specific algorithm. The term artificial intelligence commonly is used to refer to an entire system that achieves intelligence-like outcomes while using multiple sub-systems, such as multiple machine learning algorithms. But both machine learning (ML) and AI have been used to identify a variety of functionalities or types of systems that utilize various combinations of specific ML algorithms. As used herein, AI/ML engine is intended to denote a variety of AI/ML functionalities that fall under the category of AI or ML algorithms and systems that utilize such functionalities. Examples of AI/ML engine 99 can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing.

In workforce development system 100 of FIG. 1, multiple AI/ML engines 99 can be used. For example, one AI/ML engine 99 can comprise an LLM-based chatbot that interacts with any user of workforce development system 100 to provide assistance, determine expertise level, and/or suggest training opportunities. It may be that multiple different LLMs are used. For example, one LLM might be trained on a particular job, a particular task, or a particular industry. Another might be trained on collaboration. A different AI/ML engine 99 may be stored or implemented at various of the components shown in FIG. 1. Alternatively, there may be a smaller number of AI/ML engines 99, and various of the components of FIG. 1 may function as user interfaces for a remote AI/ML engine 99 stored, for example, at workforce development servers 106. Data used to train, retrain, or implement any of AI/ML engines 99 may be stored at any one or more of the components shown in FIG. 1. A person of ordinary skill in the art will recognize that a variety of such variations are possible in accordance with the present disclosure.

The architecture of an AI/ML engine 99 (e.g., structure, number of layers, nodes per layer, activation function, etc.) may need to be tailored for each particular use case. For example, properties that vary can include, e.g.: user performance data, task data, regulation data, and a variety of other factors. These may all need to be considered when designing the architecture of an AI/ML engine 99.

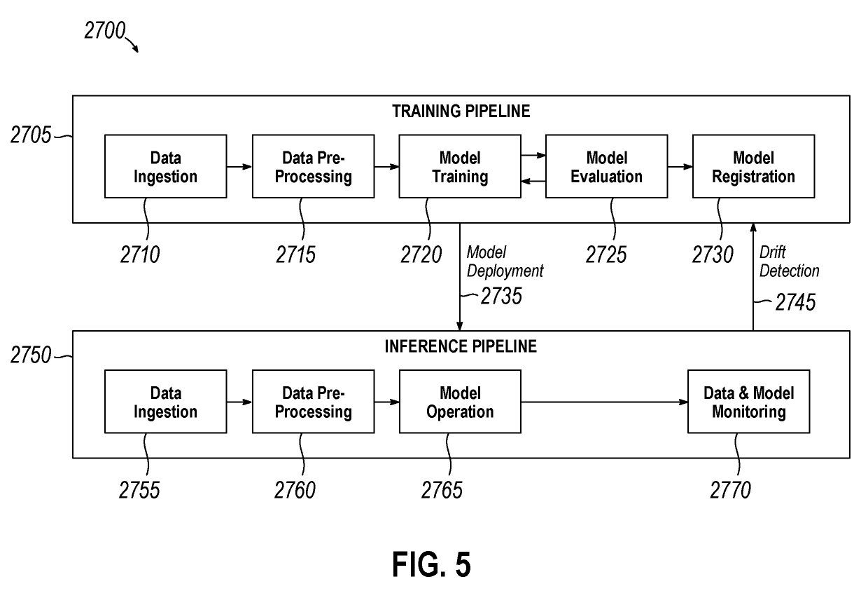

Building an AI/ML engine 99 can include several development steps where the actual training of a ML model or algorithm is just one step in a training pipeline. An important part in AI/ML development is AI/ML model lifecycle management. One embodiment of a model lifecycle management procedure 2700 is illustrated in FIG. 5. The model lifecycle management can in some embodiments comprise two pipelines: a training pipeline 2705 and an inference pipeline 2750.

At 2710 in the training pipeline 2705, data ingestion 2710 occurs, which includes gathering raw (training) data from data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model’s architecture is determined, it should be trained on one or more datasets. At 2720, model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model’s trainable parameters (e.g., the weights and biases of the underlying NN) to minimize a loss function on the training datasets. The loss function may be, for example, based on a maximizing user proficiency; minimizing necessary assistance; minimizing employee time on certain tasks, or other metrics. The purpose of the loss function is to meaningfully quantify the reconstruction error for the particular use case at hand. At 2725 model evaluation can be performed, where the performance is benchmarked to some baseline. Model training 2720 and evaluation 2725 can be iterated until an acceptable level of performance is achieved. At 2730, model registration occurs, in which the AI/ML model is registered with any corresponding data on how the AI/ML model was developed, and, e.g., AI/ML model evaluation data. At 2735, model deployment occurs, wherein the trained/re-trained AI/ML model (e.g., AI/ML engine 99) is implemented in the inference pipeline 2750.

Data ingestion 2755 in the inference pipeline 2750 refers to gathering raw (inference) data from a data source. Data pre-processing 2760 can be essentially identical or similar to the data pre-processing 2715 of the training pipeline 2705. At 2765, the operational model received from the training pipeline 2705 is used to process new data received during operation of, e.g., workforce development system 100 of FIG. 1 or components thereof. At 2770, data and model monitoring is performed. Here the inference data is analyzed to determine whether the inference data are from a statistical distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, typically comprises three components: a feedforward step, a backpropagation step, and a parameter optimization step. These steps can be described using a dense ML model (e.g., a dense NN with a bottleneck layer) as an example.

Feedforward: A batch of training data, such as a mini-batch (e.g., several downlink-channel estimates), is pushed through the ML model, from the input to the output. The loss function is used to compute the reconstruction loss for all training samples in the batch. The reconstruction loss may be an average reconstruction loss for all training samples in the batch.

Backpropagation (BP): The gradients (partial derivatives of the loss function, L, with respect to each trainable parameter in the ML model) are computed. The backpropagation algorithm sequentially works backwards from the ML model output, layer-by-layer, back through the ML model to the input. The backpropagation algorithm is built around the chain rule for differentiation: When computing the gradients for layer n in the ML model, it uses the gradients for layer n + 1.

Parameter optimization: The gradients computed in the backpropagation step are used to update the ML model’s trainable parameters. An approach is to use the gradient descent method with a learning rate hyperparameter (α) that scales the gradients of the weights and biases. It is preferred to make small adjustments to each parameter with the aim of reducing the average loss over the (mini-)batch. It is common to use special optimizers to update the ML model’s trainable parameters using gradient information. The following exemplary optimizers are widely used to reduce training time and improve overall performance: adaptive sub-gradient methods (AdaGrad), RMSProp, and adaptive moment estimation (ADAM).

The above process (feedforward, backpropagation, parameter optimization) can be repeated many times until an acceptable level of performance is achieved on the training dataset. An acceptable level of performance may refer to the ML model achieving a pre-defined average reconstruction error over the training dataset (e.g., normalized mean squared error of the reconstruction error over the training dataset is less than some threshold, say, 0.1). Alternatively, it may refer to the ML model achieving a pre-defined value chosen by a user or system engineer.

In some implementations, a function F(•) may be generated by a ML process, such as, for example, supervised learning, reinforcement learning, and/or unsupervised learning. It should be further understood that supervised learning may be done in various ways, such as, for example, using random forests, support vector machines, NNs, and the like. By way of non-limiting example, any of the following types of NNs that may be utilized, including deep neural networks (DNNs), convolutional neural networks (CNNs), and recurrent neural networks (RNNs), or any other known or future NN that satisfies the needs of the system. In an implementation using supervised learning, the NNs may easily be integrated into the hardware or described workforce development system 100 of FIG. 1 (e.g., in the form of simple vector-matrix multiplications).

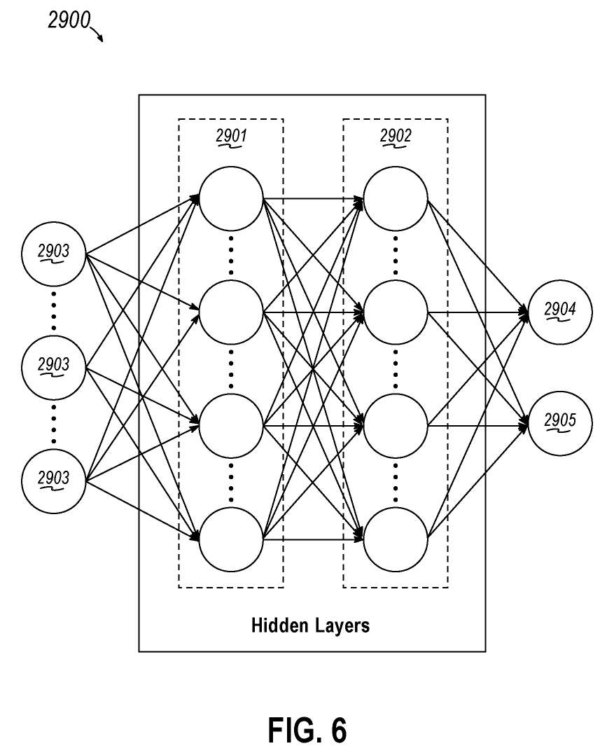

Referring now to FIG. 6, an example NN 2900 (e.g., a DNN) is shown. In some implementations, and as shown, the NN 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as outputs 2904, 2905. Outputs 2904, 2905 could be, e.g., user expertise level, suggested trainings, assistance prompts, or one or more other output variables. Possible inputs can include, e.g.: user performance data, task data, regulation data, or other variables. NN 2900 may include a different number of hidden layers, as will be understood by those skilled in the art.

As should be understood by one of ordinary skill in the art, in order for the NN 2900 to output a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

### Additional Embodiments

In some embodiments, multiple users may collaborate while the workforce development system 100 assists the collaboration between the users. This may include performing method 200 of FIG. 2, but instead of task assistance being provided 204, the assistance may be collaboration assistance. For example, the workforce development system 100 may suggest talking points, meeting opportunities, processes, or other collaboration assistance for one or more tasks based on the users’ performance data.

In some embodiments, user performance data may be analyzed along with third-party or other data including industry trends, emerging skills, and/or other workforce training data, together being referred to as workforce training data. This workforce training data may be provided to the workforce development system 100 by a user, scraped from third-party websites and/or apps, or otherwise acquired. This workforce training data may be used to generate recommendations for targeted training for particular skills, advanced assistance to aid the user in learning new skills, or other functions.

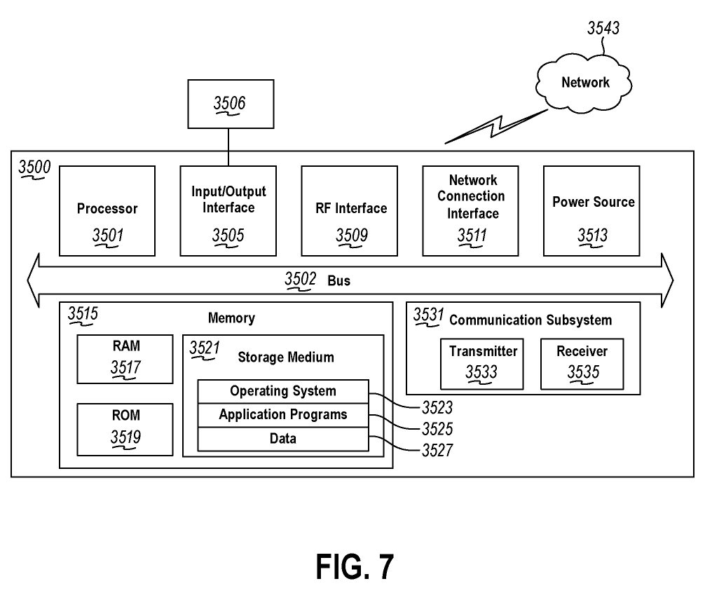

FIG. 7 illustrates an embodiment of various computing devices within workforce development system 100 of FIG. 1, or components thereof, e.g., workforce development servers 106, user computing devices 102, and/or data management servers 112, which can comprise, e.g., computers, tablets, servers, databases, mobile devices, or other computing or smart devices described herein. FIG. 7 shows a schematic block diagram of a computing device 3500 (or components thereof) according to certain embodiments of the present disclosure. System 3500 can be used to analyze and/or optimize the functionalities described with respect to workforce development system 100 of FIG. 1 and its components, or to perform other methods, such as AI- or ML-related tasks and analyses as described herein.

In the example embodiment shown in FIG. 7, computing device 3500 includes processor 3501 that is operatively coupled via a bus 3502 to an input/output interface 3505, a power source 3513, a memory 3515, a RF interface 3509, network communication interface 3511, and/or any other component, or any combination thereof. The level of integration between the components may vary from one embodiment to another. Further, certain computing devices 3500 (or components thereof) may contain multiple instances of a component, such as multiple processors, memories, transceivers, transmitters, receivers, etc.

The processor 3501 is configured to process instructions and data and may be configured to implement any sequential state machine operative to execute instructions stored as machine-readable computer programs in memory 3515. Processor 3501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 3501 may include multiple central processing units (CPUs).

In the example, input/output interface 3505 may be configured to provide one or more interfaces to an input/output device(s) 3506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 3500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 3513 is structured as a battery or battery pack. Other types of power sources, such as an external power source (e.g., an electricity outlet), photovoltaic device, or power cell, may be used. The power source 3513 may further include power circuitry for delivering power from the power source 3513 itself, and/or an external power source, to the various parts of computing device 3500 via input circuitry or an interface such as an electrical power cable.

Memory 3515 may be configured to include memory such as random access memory (RAM) 3517, read-only memory (ROM) 3519, programmable read-only memory (PROM), erasable programmable read-only memory (EPROM), electrically erasable programmable read-only memory (EEPROM), magnetic disks, optical disks, hard disks, removable cartridges, flash drives, other storage medium 3521, and so forth. In one example, the memory 3515 includes one or more application programs 3525, an operating system 3523, web browser application, a widget, gadget engine, or other application, and corresponding data 3527. Memory 3515 may store, for use by the computing device 3500, any of a variety of various operating systems or combinations of operating systems. An article of manufacture, such as one including a workforce development system, may be tangibly embodied as or in memory 2515, which may be or comprise a device-readable storage medium.

Processor 3501 may be configured to communicate with an access network or other network using the RF interface 3509 or network connection interface 3511. The RF interface 3509 or network connection interface 3511 may comprise one or more communication subsystems and may include or be communicatively coupled to an antenna. In the illustrated embodiment, communication functions of the RF interface 3509 or network connection interface 3511 may include cellular communication, WI-FI® communication, LPWAN communication, data communication, voice communication, multimedia communication, short-range communications such as Bluetooth®, near-field communication (NFC), location-based communication such as the use of the global positioning system (GPS) to determine a location, another like communication function, or any combination thereof.

Workforce development system 100 of FIG. 1, or computing devices 3500 as described above or in regard to FIG. 1, can perform a variety of method embodiments under the present disclosure. Several example method embodiments are given above, but these examples are non-limiting and are only meant to illustrate certain embodiments.

Although the computing devices described herein (e.g., servers, computing devices, etc. of workforce development system 100 of FIG. 1) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to stored information, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware, and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether or not executing instructions stored on a non-transitory computer-readable storage medium, the processing circuitry can be configured to perform the described functionality. The benefits provided by such functionality are not limited to the processing circuitry alone or to other components of the computing device, but are enjoyed by the computing device as a whole, and/or by end users and a network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special-purpose chips, circuits, software, logic, or any combination thereof. For example, some aspects may be implemented in hardware, while other aspects may be implemented in firmware or software that may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special-purpose circuits or logic, general-purpose hardware or controllers or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms, as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

The following non-exhaustive examples relate to various ways in which the teachings herein may be combined or applied. It should be understood that the following examples are not intended to restrict the coverage of any claims that may be presented at any time in this application or in subsequent filings related to this application. No disclaimer is intended. The following examples are being provided for nothing more than merely illustrative purposes. It is contemplated that the various teachings herein may be arranged and applied in numerous other ways. It is also contemplated that some variations may omit certain features referred to in the examples below. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

Example 1 is a workforce development system, comprising: a processor; and a memory storing instructions whereby the processor is configured to perform the steps of: collecting performance data about a user; assisting the user based on the performance data; presenting one or more skill tests to the user such that the user is unaware of the testing; analyzing the performance data with an AI/ML engine; and optimizing the assistance to the user based on the analyzed performance data.

Example 2 is the system of example 1, wherein the instructions further cause the processor to perform the step of generating a performance report based on the performance data.

Example 3 is the system of example 1, wherein the performance data comprises biometric data.

Example 4 is the system of example 1, wherein the instructions further implement a training pipeline and an inference pipeline, wherein: the training pipeline ingests training data and uses the ingested training data to train the AI/ML engine; the trained model is deployed from the training pipeline to the inference pipeline; and the analyzing step comprises the inference pipeline applying the deployed model to the performance data to yield the analyzed performance data.

Example 5 is the system of example 4, wherein the AI/ML engine comprises a neural network.

Example 6 is the system of example 4, wherein the inference pipeline comprises monitoring whether a statistical distribution of the performance data aligns with a statistical distribution of the training data.

Example 7 is the system of example 4, wherein the inference pipeline comprises monitoring the analyzed performance data for performance, or operational, variance or drifts.

Example 8 is a method performed by a workforce development system for customizing and optimizing assistance, comprising the steps of: collecting performance data about a user; providing assistance to the user based on the performance data; presenting one or more skill tests to the user such that the user is unaware of the testing; analyzing the performance data with an AI/ML engine; and optimizing assistance based on the analysis of the performance data.

Example 9 is the method of example 8, further comprising generating a performance report based on the performance data.

Example 10 is the method of example 8, wherein the performance data comprises biometric data.

Example 11 is the method of example 8, further comprising implementing a training pipeline and an inference pipeline, wherein: the training pipeline ingests training data and uses the ingested training data to train the AI/ML engine; the trained model is deployed from the training pipeline to the inference pipeline; and the analyzing step comprises the inference pipeline applying the deployed model to the performance data to yield the analyzed performance data.

Example 12 is the method of example 11, wherein the AI/ML model comprises a neural network.

Example 13 is the method of example 11, wherein the inference pipeline comprises monitoring whether a statistical distribution of the performance data aligns with a statistical distribution of the training data.

Example 14 is the method of example 11, wherein the inference pipeline comprises monitoring the analyzed performance data for performance, or operational, variance or drifts.

Example 15 is a computer-implemented method for training a machine learning model for optimizing a workforce development system, the method comprising: obtaining a dataset of identified training outcomes; training the machine learning model using the dataset of identified training outcomes, thereby obtaining a trained machine learning model; storing the trained machine learning model; and applying the trained machine learning model to one or more inputs to yield workforce development suggestions.

Example 16 is the computer-implemented method of example 15, further comprising training a machine learning model for optimizing identified training outcomes, wherein the training comprises; training the machine learning model using a dataset of one or more identified training outcomes, thereby obtaining a further trained machine learning model; and storing the further trained machine learning model.

Example 17 is the computer-implemented method of example 15, wherein the one or more identified training outcomes comprise one or more of: user expertise level, suggested trainings, assistance prompts.

Example 18 is the computer-implemented method of example 15, wherein the one or more inputs comprise one or more of: user performance data, task data, regulation data, task data.

Example 19 is the computer-implemented method of example 15, wherein the one or more inputs comprise biometric data.

Example 20 is the computer-implemented method of example 15, further comprising generating a performance report based on the workforce development suggestions.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second,” etc., may be used herein to describe various elements, the ordering, position, label, or appearance of these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises,” “comprising,” “has,” “having,” “includes,” and/or “including,” when used herein, specify the presence of stated features, elements, and/or components, etc., but do not preclude the presence or addition of one or more other features, elements, components, and/or combinations thereof.

### Conclusion

The present disclosure includes any novel feature or combination of either features disclosed herein explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A workforce development system, comprising:
a processor; and
a memory storing instructions whereby the processor is configured to perform the steps of:
collecting performance data about a user;
assisting the user based on the performance data;
presenting one or more skill tests to the user such that the user is unaware of the testing;
analyzing the performance data with an AI/ML engine; and
optimizing the assistance to the user based on the analyzed performance data.

2. The system of claim , wherein the instructions further cause the processor to perform the step of generating a performance report based on the performance data.

3. The system of claim 1, wherein the performance data comprises biometric data.

4. The system of claim 1, wherein the instructions further implement a training pipeline and an inference pipeline, wherein:
the training pipeline ingests training data and uses the ingested training data to train the AI/ML engine;
the trained model is deployed from the training pipeline to the inference pipeline; and
the analyzing step comprises the inference pipeline applying the deployed model to the performance data to yield the analyzed performance data.

5. The system of claim , wherein the AI/ML engine comprises a neural network.

6. The system of claim , wherein the inference pipeline comprises monitoring whether a statistical distribution of the performance data aligns with a statistical distribution of the training data.

7. The system of claim , wherein the inference pipeline comprises monitoring the analyzed performance data for performance, or operational, variance or drifts.

8. A method performed by a workforce development system for customizing and optimizing assistance, comprising the steps of:
collecting performance data about a user;
providing assistance to the user based on the performance data;
presenting one or more skill tests to the user such that the user is unaware of the testing;
analyzing the performance data with an AI/ML engine; and
optimizing assistance based on the analysis of the performance data.

9. The method of claim , further comprising generating a performance report based on the performance data.

10. The method of claim , wherein the performance data comprises biometric data.

11. The method of claim , further comprising implementing a training pipeline and an inference pipeline, wherein:
the training pipeline ingests training data and uses the ingested training data to train the AI/ML engine;
the trained model is deployed from the training pipeline to the inference pipeline; and
the analyzing step comprises the inference pipeline applying the deployed model to the performance data to yield the analyzed performance data.

12. The method of claim , wherein the AI/ML model comprises a neural network.

13. The method of claim , wherein the inference pipeline comprises monitoring whether a statistical distribution of the performance data aligns with a statistical distribution of the training data.

14. The method of claim , wherein the inference pipeline comprises monitoring the analyzed performance data for performance, or operational, variance or drifts.

15. A computer-implemented method for training a machine learning model for optimizing a workforce development system, the method comprising:
obtaining a dataset of identified training outcomes;
training the machine learning model using the dataset of identified training outcomes, thereby obtaining a trained machine learning model;
storing the trained machine learning model; and
applying the trained machine learning model to one or more inputs to yield workforce development suggestions.

16. The method of claim , further comprising training a machine learning model for optimizing identified training outcomes, wherein the training comprises;
training the machine learning model using a dataset of one or more identified training outcomes, thereby obtaining a further trained machine learning model; and
storing the further trained machine learning model.

17. The method of claim , wherein the one or more identified training outcomes comprise one or more of: user expertise level, suggested trainings, assistance prompts.

18. The method of claim , wherein the one or more inputs comprise one or more of: user performance data, task data, regulation data, task data.

19. The method of claim , wherein the one or more inputs comprise biometric data.

20. The method of claim , further comprising generating a performance report based on the workforce development suggestions.
